(19) United States
(12) Patent Application Publication
(10) Pub. No.: US 2026/0149502 A1
(43) Pub. Date: May 28, 2026

(54) INFORMATION PROCESSING DEVICE, OPTICAL COMMUNICATION SYSTEM, AND OPTICAL RELAY DEVICE

(71) Applicant: NEC Corporation, Tokyo (JP)

(72) Inventor: Sadaichirou OOGUSHI, Tokyo (JP)

(73) Assignee: NEC Corporation, Tokyo (JP)

(21) Appl. No.: 19/386,286

(22) Filed: Nov. 12, 2025

(30) Foreign Application Priority Data
Nov. 25, 2024 (JP) 2024-204432

(51) Int. Cl. H04B 10/29; H04B 10/564

(52) U.S. Cl. CPC H04B 10/29; H04B 10/564

(57) ABSTRACT

There is provided an information processing device including an acquisition unit that acquires information indicating whether a detachable optical amplifier that amplifies at least one of a transmission optical signal and a reception optical signal is connected to a first optical relay device, a determination unit that determines, in a case where the detachable optical amplifier is connected to the first optical relay device, a gain of the detachable optical amplifier based on a signal quality between the first optical relay device and a second optical relay device that communicates with the first optical relay device by an optical signal, and a control unit that causes the gain determined by the determination unit to be set in the detachable optical amplifier.

### SPECIFICATION

### INCORPORATION BY REFERENCE

This application is based upon and claims the benefit of priority from Japanese patent application No. 2024-204432, filed on November 25, 2024, the disclosure of which is incorporated herein in its entirety by reference.

### TECHNICAL FIELD

The present disclosure relates to an information processing device, an optical communication system, and an optical relay device.

### BACKGROUND ART

It is known that after a received optical signal is amplified by an amplifier, the optical signal is converted into an electrical signal by a transponder, and the optical signal converted from the electrical signal by the transponder is amplified by the amplifier and transmitted (e.g., WO 2021/106031 A1).

### SUMMARY

However, in the technique described in WO 2021/106031 A1, for example, there is room for improvement in the arrangement of amplifiers.

In view of the above-described problems, an example object of the present disclosure is to provide a technique capable of appropriately arranging amplifiers in an optical communication system.

According to a first example aspect of the present disclosure, there is provided an information processing device including an acquisition unit that acquires information indicating whether a detachable optical amplifier that amplifies at least one of a transmission optical signal and a reception optical signal is connected to a first optical relay device, a determination unit that determines, in a case where the detachable optical amplifier is connected to the first optical relay device, a gain of the detachable optical amplifier based on a signal quality between the first optical relay device and a second optical relay device that communicates with the first optical relay device by an optical signal, and a control unit that causes the gain determined by the determination unit to be set in the detachable optical amplifier.

Furthermore, according to a second example aspect of the present disclosure, there is provided an optical communication system including an information processing device, a detachable optical amplifier that amplifies at least one of a transmission optical signal and a reception optical signal, and a first optical relay device, in which the information processing device includes an acquisition unit that acquires information indicating whether the detachable optical amplifier is connected to the first optical relay device, a determination unit that determines, in a case where the detachable optical amplifier is connected to the first optical relay device, a gain of the detachable optical amplifier based on a signal quality between the first optical relay device and a second optical relay device that communicates with the first optical relay device by an optical signal, and a control unit that causes the gain determined by the determination unit to be set in the detachable optical amplifier.

In addition, according to a third example aspect of the present disclosure, there is provided an optical relay device including a detachable portion to which a detachable optical amplifier that amplifies at least one of a transmission optical signal and a reception optical signal is detachable, and a control unit that sets, in the detachable optical amplifier, a gain setting according to a signal quality between the optical relay device and another optical relay device that communicates with the optical relay device by an optical signal.

According to one aspect, an example advantage is that the amplifiers can be appropriately arranged in the optical communication system.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram illustrating an example of a configuration of an information processing device according to an example embodiment;

FIG. 2 is a diagram illustrating a configuration example of an optical communication system according to the example embodiment;

FIG. 3 is a diagram illustrating a configuration example of an optical relay device according to the example embodiment;

FIG. 4 is a diagram illustrating a hardware configuration example of an information processing device according to the example embodiment; and

FIG. 5 is a flowchart illustrating an example of processing of the information processing device according to the example embodiment.

### EXAMPLE EMBODIMENT

The principles of the present disclosure will be described with reference to several exemplary example embodiments. It is to be understood that the example embodiments have been described for purposes of illustration only and will aid those skilled in the art in understanding and carrying out the present disclosure without suggesting limitations on the scope of the present disclosure. The disclosure described in the present description is implemented in various methods other than those described below.

In the following description and claims, unless defined otherwise, all technical and scientific terms used in the present specification have the same meaning as commonly understood by those skilled in the art of the technical field to which the present disclosure belongs.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

### First Example Embodiment

### Configuration

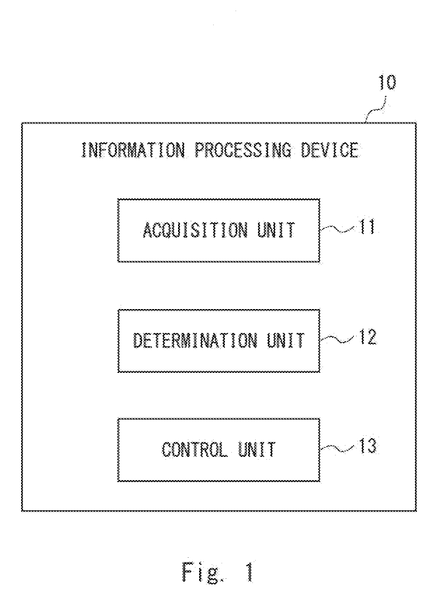

Next, a configuration of an information processing device 10 according to an example embodiment will be described with reference to FIG. 1. FIG. 1 is a diagram illustrating an example of the configuration of the information processing device 10 according to the example embodiment. The information processing device 10 includes an acquisition unit 11, a determination unit 12, and a control unit 13. These units may be achieved by cooperation of one or more programs installed in the information processing device 10 and hardware such as a processor or a memory of the information processing device 10.

The acquisition unit 11 acquires information indicating whether a detachable optical amplifier that amplifies at least one of a transmission optical signal and a reception optical signal is connected to a first optical relay device. In a case where the detachable optical amplifier is connected to the first optical relay device, the determination unit 12 determines the gain of the detachable optical amplifier based on the signal quality between the first optical relay device and a second optical relay device that communicates with the first optical relay device by an optical signal. The control unit 13 sets the gain determined by the determination unit 12 to the detachable optical amplifier.

### Second Example Embodiment

### System Configuration

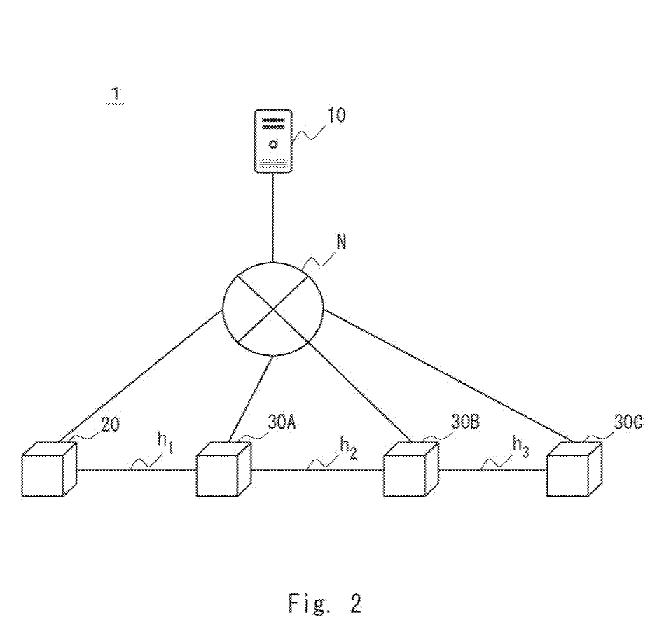

Next, a configuration of an optical communication system 1 according to the example embodiment will be described with reference to FIG. 2. FIG. 2 is a diagram illustrating a configuration example of an optical communication system 1 according to the example embodiment. In the example of FIG. 2, the optical communication system 1 includes an information processing device 10 and an optical relay device 20. In addition, the optical communication system 1 includes a station optical relay device 30A, a station optical relay device 30B, and a station optical relay device 30C (hereinafter, in a case where there is no need to distinguish, they are also simply referred to as the “station optical relay device 30”). In the example of FIG. 2, the information processing device 10, the optical relay device 20, and the station optical relay device 30 are connected in such a way as to be able to communicate via the network N. The numbers of information processing devices 10, optical relay devices 20, and station optical relay devices 30 are not limited to the example of FIG. 2.

Examples of the network N include, for example, the Internet, a mobile communication system, a wireless Local Area Network (LAN), a LAN, and a bus. Examples of the mobile communication system include, for example, a fifth generation mobile communication system (5G), a sixth generation mobile communication system (6G, Beyond 5G), a fourth generation mobile communication system (4G), and a third generation mobile communication system (3G).

The information processing device 10 may be, for example, a device such as a server, a cloud server, a personal computer, or a microcomputer. For example, the information processing device 10 may manage the optical relay device 20.

In the example of FIG. 2, the optical relay device 20 and the station optical relay device 30A transmit and receive (communicate) data by an optical signal using an optical transmission line h₁. In addition, the station optical relay device 30A and the station optical relay device 30B transmit and receive data by an optical signal using an optical transmission line h₂. Furthermore, the station optical relay device 30B and the station optical relay device 30C transmit and receive data by an optical signal using an optical transmission line h₃.

The optical relay device 20 is, for example, an optical relay device installed in various facilities such as a user's home. The optical relay device 20 amplifies an optical signal used for communication using a detachable optical amplifier. The station optical relay device 30 is, for example, an optical relay device installed in various facilities of an optical communication provider or the like. The station optical relay device 30 includes a multiplexer that multiplexes an optical signal output from each transponder, and an amplifier that amplifies the multiplexed optical signal. For example, the station optical relay device 30A multiplexes and amplifies the optical signal from each optical relay device 20 installed in each user's home, and then transfers the multiplexed optical signal to the station optical relay device 30B.

### Configuration of Optical Relay Device 20

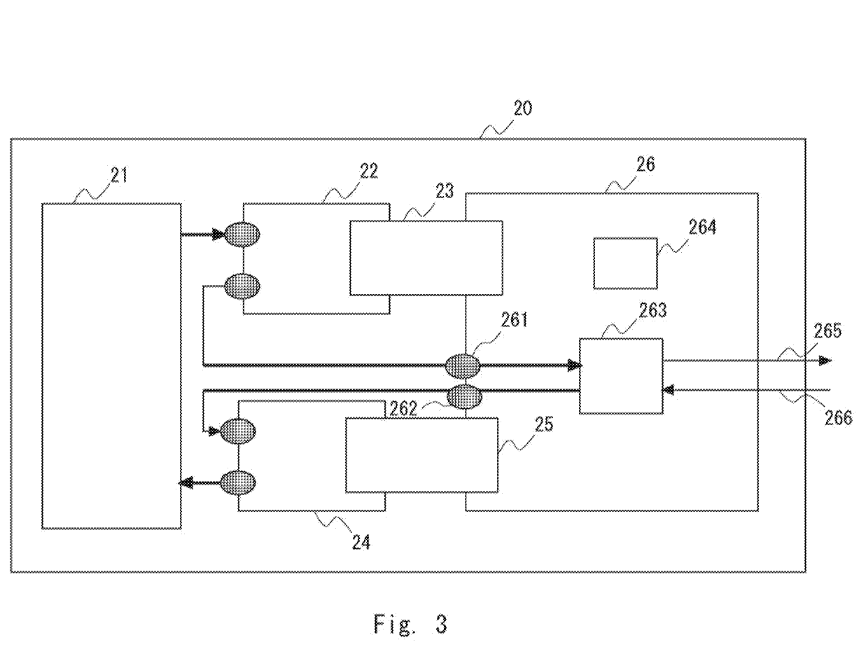

Next, a configuration of the optical relay device 20 according to the example embodiment will be described with reference to FIG. 3. FIG. 3 is a diagram illustrating a configuration example of the optical relay device 20 according to the example embodiment. In the example of FIG. 3, the optical relay device 20 includes an optical transponder 21, a transmitting-side detachable optical amplifier 22, a pluggable electrical connector 23, a receiving-side detachable optical amplifier 24, a pluggable electrical connector 25, and an optical communication device 26. The optical communication device 26 includes a receptacle 261, a receptacle 262, a filter 263, and a control unit 264. Each of the transmitting-side detachable optical amplifier 22 and the receiving-side detachable optical amplifier 24 is an example of a “detachable optical amplifier”. Hereinafter, in a case where it is not necessary to distinguish between the transmitting-side detachable optical amplifier 22 and the receiving-side detachable optical amplifier 24, each of the transmitting-side detachable optical amplifier 22 and the receiving-side detachable optical amplifier 24 is also appropriately referred to as a “detachable optical amplifier”. The transmitting-side detachable optical amplifier 22 and the receiving-side detachable optical amplifier 24 may be configured as an integrated device, or may be configured as separate devices.

The optical transponder 21 converts transmission data input from an external device or the like from an electric signal into an optical signal and outputs the optical signal to the transmitting-side detachable optical amplifier 22. In a case where the transmitting-side detachable optical amplifier 22 is not attached to the optical relay device 20, the optical transponder 21 outputs an optical signal of transmission data to the optical communication device 26. In addition, the optical transponder 21 converts an optical signal of reception data received from the receiving-side detachable optical amplifier 24 into an electric signal and outputs the electric signal to an external device or the like. In a case where the receiving-side detachable optical amplifier 24 is not attached to the optical relay device 20, the optical transponder 21 inputs an optical signal of reception data from the optical communication device 26.

The transmitting-side detachable optical amplifier 22 amplifies the optical signal input from the optical transponder 21 and outputs the amplified optical signal to the optical communication device 26. In addition, the transmitting-side detachable optical amplifier 22 transmits and receives an electric signal for control to and from the optical communication device 26 via the pluggable electrical connector 23. In a case where the transmission line loss or the like on the transmitting side is relatively small, the transmitting-side detachable optical amplifier 22 is unnecessary. As a result, the amplifier can be made unnecessary if it is not necessary, so that the cost (expense) of the amplifier can be reduced.

The receiving-side detachable optical amplifier 24 amplifies the optical signal input from the optical communication device 26 and outputs the amplified optical signal to the optical transponder 21. In addition, the receiving-side detachable optical amplifier 24 transmits and receives an electric signal for control to and from the optical communication device 26 via the pluggable electrical connector 25. In a case where the transmission line loss or the like on the receiving side is relatively small, the receiving-side detachable optical amplifier 24 is unnecessary. As a result, the amplifier can be made unnecessary if it is not necessary, so that the cost (expense) of the amplifier can be reduced. The pluggable electrical connector 23 and the pluggable electrical connector 25 may be connectors conforming to a standard such as, for example, a Small Form-factor Pluggable (SFP).

The receptacle 261 is a connector to which an optical signal of transmission data is input. The receptacle 262 is a connector to which an optical signal of reception data is input. The receptacle 261, the receptacle 262, the transmitting-side detachable optical amplifier 22, and the receiving-side detachable optical amplifier 24 may be provided on the same surface of a housing of the optical communication device 26. This is considered to contribute to, for example, improvement in efficiency of fiber connection work.

The filter 263 superimposes an optical signal (main signal) of transmission data and a transmission management optical signal and transmits the superimposed optical signal to the station optical relay device 30 via the transmission optical fiber 265. In addition, the filter 263 separates the optical signal (main signal) of the reception data received via the reception optical fiber 266 and the reception management optical signal. The frequency of the main signal on the transmitting side is different from the frequency of the transmission management optical signal. In addition, the frequency of the main signal on the receiving side is different from the frequency of the reception management optical signal.

The control unit 264 controls each unit of the optical communication device 26 or the like. Furthermore, the control unit 264 calculates (estimates) the signal quality on the transmitting side and the signal quality on the receiving side using the management optical signal.

### Hardware Configuration of Information Processing Device 10

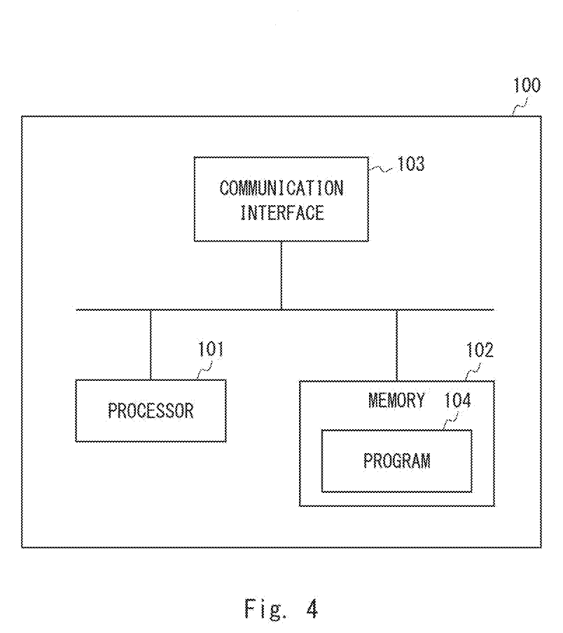

FIG. 4 is a diagram illustrating a hardware configuration example of the information processing device 10 according to the example embodiment. In the example of FIG. 4, the information processing device 10 (computer 100) includes a processor 101, a memory 102, and a communication interface 103. These units may be connected by a bus or the like. The memory 102 stores at least a part of a program 104. The communication interface 103 includes an interface necessary for communication with other network elements.

In a case where the program 104 is executed by the processor 101, the memory 102, and the like in cooperation with each other, at least some processing according to the example embodiment of the present disclosure is performed by the computer 100. The memory 102 may be of any type. The memory 102 may be a non-transitory computer-readable storage medium, as a non-limiting example. The memory 102 may also be implemented using any appropriate data storage technique such as a semiconductor-based memory device, a magnetic memory device and system, an optical memory device and system, a fixed memory, and a removable memory. Although only one memory 102 is illustrated in the computer 100, there may be several physically different memory modules in the computer 100. The processor 101 may be of any type. The processor 101 may include one or more of a general purpose computer, a dedicated computer, a microprocessor, a Digital Signal Processor (DSP), and a processor based on a multi-core processor architecture as a non-limiting example. The computer 100 may include a plurality of processors, such as an application specific integrated circuit chip that is temporally dependent on a clock that synchronizes the main processor.

Example embodiments of the present disclosure may be implemented in hardware or dedicated circuitry, software, logic, or any combination thereof. Some aspects may be implemented in hardware, while other aspects may be implemented in firmware or software that may be executed by a controller, a microprocessor, or another computing device.

The present disclosure also provides at least one computer program product tangibly stored in a non-transitory computer-readable storage medium. The computer program product includes computer-executable instructions, such as instructions included in a program module, and is executed on a device on a target real or virtual processor to execute the processes or methods of the present disclosure. The program module includes routines, programs, libraries, objects, classes, components, data structures, and the like that execute specific tasks or implement specific abstract data types. Functions of the program module may be combined or divided between the program modules as desired in various example embodiments. A machine-executable instruction of the program module can be executed in a local or distributed device. In the distributed device, the program modules may be arranged on both local and remote storage media.

Program codes for executing the method of the present disclosure may be written in any combination of one or more programming languages. These program codes are provided to a processor or controller of a general purpose computer, a dedicated computer, or other programmable data processing devices. In a case where the program codes are executed by the processor or controller, the functions/operations in the flowcharts and/or the implemented block diagrams are executed. The program codes are executed entirely on the machine, partially on the machine, as a stand-alone software package, partially on the machine, partially on a remote machine, or entirely on the remote machine or server.

The program includes instruction groups (or software codes) for causing the computer to perform one or more functions described in the example embodiment in a case of being read by the computer. The programs may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technique, a CD-ROM, a digital versatile disc (DVD), a Blu-ray (registered trademark) disc or any other optical disc storage, and a magnetic cassette, a magnetic tape, a magnetic disk storage, or any other magnetic storage device. The program may be transmitted through a transitory computer-readable medium or a communication medium. As an example and not by way of limitation, the transitory computer-readable medium or communication medium includes electrical, optical, acoustic, or other forms of propagation signals.

### Processing

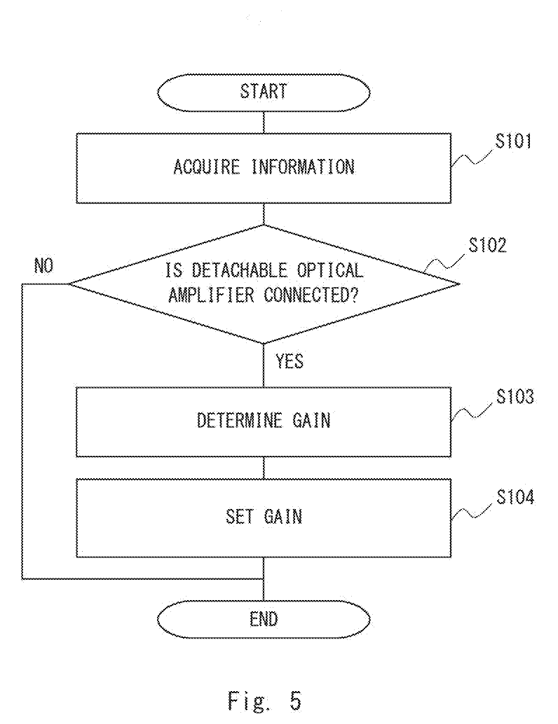

Next, an example of processing of the information processing device 10 according to the example embodiment will be described with reference to FIG. 5. FIG. 5 is a flowchart illustrating an example of the processing of the information processing device 10 according to the example embodiment. The processing of FIG. 4 may be executed, for example, at regular timing or the like.

In step S101, the acquisition unit 11 acquires information indicating whether the detachable optical amplifier is connected to the optical relay device 20. The information indicating whether the transmitting-side detachable optical amplifier 22 is connected to the optical relay device 20 may be acquired using, for example, the pluggable electrical connector 23. Furthermore, the information indicating whether the receiving-side detachable optical amplifier 24 is connected to the optical relay device 20 may be acquired using, for example, the pluggable electrical connector 25.

Subsequently, the determination unit 12 determines whether the detachable optical amplifier is connected to the optical relay device 20 (step S102). In a case where the detachable optical amplifier is not connected to the optical relay device 20 (NO in step S102), the processing ends. More specifically, in a case where both the transmitting-side detachable optical amplifier 22 and the receiving-side detachable optical amplifier 24 are not connected to the optical relay device 20, the processing ends.

In a case where the detachable optical amplifier is connected to the optical relay device 20 (YES in step S102), the determination unit 12 determines the gain of the detachable optical amplifier (step S103). Here, in a case where the transmitting-side detachable optical amplifier 22 is connected to the optical relay device 20, the determination unit 12 determines the gain of the transmitting-side detachable optical amplifier 22 based on the signal quality (transmission quality) of a transmission line for transmission between the optical relay device 20 and the station optical relay device 30A. In this case, for example, the determination unit 12 may calculate the signal quality by the transmission line for transmission based on the attenuation degree of the transmission management optical signal transmitted from the optical relay device 20 and received by the station optical relay device 30A. In this case, for example, the determination unit 12 may determine the value indicating the signal quality to be lower the higher the attenuation degree of the optical signal.

In addition, in a case where the receiving-side detachable optical amplifier 24 is connected to the optical relay device 20, the determination unit 12 may determine the gain of the receiving-side detachable optical amplifier 24 based on the signal quality of a transmission line for reception between the optical relay device 20 and the station optical relay device 30A. In this case, for example, the determination unit 12 may calculate the signal quality by the transmission line for reception based on the attenuation degree of the reception management optical signal transmitted from the station optical relay device 30A and received by the optical relay device 20. In a case where both the transmitting-side detachable optical amplifier 22 and the receiving-side detachable optical amplifier 24 are connected to the optical relay device 20, the determination unit 12 determines the gains for both.

Subsequently, the control unit 13 sets the gain determined by the determination unit 12 to the detachable optical amplifier (step S104). As a result, for example, an appropriate gain according to the loss in the transmission line can be provided.

In a case where the transmitting-side detachable optical amplifier 22 is connected to the optical relay device 20, the control unit 13 sets the gain of the transmitting-side detachable optical amplifier 22 using the pluggable electrical connector 23. Furthermore, in a case where the receiving-side detachable optical amplifier 24 is connected to the optical relay device 20, the control unit 13 sets the gain of the receiving-side detachable optical amplifier 24 using the pluggable electrical connector 25. In a case where both the transmitting-side detachable optical amplifier 22 and the receiving-side detachable optical amplifier 24 are connected to the optical relay device 20, the control unit 13 sets the gain for both.

Hereinafter, an example of each function of the option of the information processing device 10 will be described. The processing of each function described below can be appropriately combined and used.

### Example of Notifying Warning in Case Where Gain Setting is Inappropriate

The information processing device 10 may notify an alarm in a case where the gain setting is inappropriate. As a result, for example, even in a case where the gain setting fails due to the detachable optical amplifier being removed from the pluggable electrical connector by the user or the like at the time of setting the gain, the failure in gain setting can be notified to the user.

In this case, the acquisition unit 11 may acquire information indicating the gain set in the detachable optical amplifier. Here, the acquisition unit 11 may acquire a set value of the current gain of the transmitting-side detachable optical amplifier 22 by using the pluggable electrical connector 23. In addition, the acquisition unit 11 may acquire a set value of the current gain of the receiving-side detachable optical amplifier 24 by using the pluggable electrical connector 25.

Then, in a case where the gain set in the detachable optical amplifier is different from the gain determined by the determination unit 12, the control unit 13 may cause a warning to be notified. Here, in a case where the set value of the current gain of the transmitting-side detachable optical amplifier 22 is different from the gain of the transmitting-side detachable optical amplifier 22 determined by the determination unit 12, the control unit 13 may cause a warning to be notified to the user by the optical relay device 20 or the transmitting-side detachable optical amplifier 22.

Furthermore, in a case where the set value of the current gain of the receiving-side detachable optical amplifier 24 is different from the gain of the receiving-side detachable optical amplifier 24 determined by the determination unit 12, the control unit 13 may cause a warning to be notified to the user by the optical relay device 20 or the receiving-side detachable optical amplifier 24. The control unit 13 may cause a warning to be notified by a warning lamp, a display, or a speaker provided in the optical relay device 20 or the detachable optical amplifier.

Furthermore, in a case where the gain setting is inappropriate, the control unit 13 may cause information indicating the gain determined by the determination unit 12 to be notified. As a result, for example, even in a case where the gain setting has failed, the user can appropriately set the gain by manual operation or the like.

### Example of Setting Gain According to Type of Detachable Optical Amplifier

The information processing device 10 may set a gain according to the type of the detachable optical amplifier. As a result, for example, even in a case where the accuracy or the like of the amplification of the optical signal of the angular frequency is different according to the type of the detachable optical amplifier, the gain can be set more appropriately.

In this case, the information processing device 10 may perform the following processing for each of the transmitting side and the receiving side. The acquisition unit 11 may acquire information indicating the type of the detachable optical amplifier. Then, the determination unit 12 may determine the gain of the detachable optical amplifier based on the type of the detachable optical amplifier and the signal quality. Here, the determination unit 12 may determine the gain by using, for example, a table in which the gain of the detachable optical amplifier is set with respect to a combination of the type of the detachable optical amplifier and the signal quality. In this case, the information of the table may be set in advance in the information processing device 10 by an operator (administrator) or the like. In addition, for example, the determination unit 12 may determine the gain by using a trained model in which the type of the detachable optical amplifier and the signal quality are the inputs (explanatory variable) and the gain of the detachable optical amplifier is the output (objective variable). In this case, the trained model may be set in advance in the information processing device 10 by an operator (administrator) or the like.

### Example of Notifying User That Detachable Optical Amplifier Is Necessary in Case Where Detachable Optical Amplifier Is Necessary

In a case where the detachable optical amplifier is necessary, the information processing device 10 may notify the user of that fact. Thus, for example, the user can install the detachable optical amplifier only in a case where the detachable optical amplifier is necessary.

In this case, the information processing device 10 may perform the following processing for each of the transmitting side and the receiving side. In a case where the detachable optical amplifier is not connected to the optical relay device 20 and the signal quality is equal to or less than a threshold value, the control unit 13 may cause information indicating that connection of the detachable optical amplifier is necessary to be notified.

### Example of Notifying User That Detachable Optical Amplifier Is Unnecessary in Case Where Detachable Optical Amplifier Is Unnecessary

In a case where the detachable optical amplifier is unnecessary, the information processing device 10 may notify the user of that fact. As a result, for example, since the user can grasp that the detachable optical amplifier is unnecessary, it is possible to eliminate the expense of the detachable optical amplifier by returning the detachable optical amplifier or the like.

In this case, the information processing device 10 may perform the following processing for each of the transmitting side and the receiving side. In a case where the detachable optical amplifier is not connected to the optical relay device 20 and the signal quality is not equal to or less than a threshold value, the control unit 13 may cause information indicating that connection of the detachable optical amplifier is unnecessary to be notified.

Furthermore, in a case where the detachable optical amplifier is connected to the optical relay device 20 and the signal quality is not equal to or less than the threshold value without increasing the gain by the detachable optical amplifier, the control unit 13 may cause information indicating that connection of the detachable optical amplifier is unnecessary to be notified. In this case, the control unit 13 may set the gain (the ratio of the input and the output in the amplifier) by the detachable optical amplifier to one and measure the signal quality.

### Example of Determining Whether to Maintain Gain Setting When Restarting Optical Relay Device 20

The information processing device 10 may determine whether to maintain the setting of the gain of the detachable optical amplifier when restarting the optical relay device 20. As a result, for example, in a case where the optical relay device 20 is restarted to reflect the update (update) of the firmware or the like of the optical relay device 20, the re-measurement of the signal quality can be appropriately omitted.

In this case, the information processing device 10 may perform the following processing for each of the transmitting side and the receiving side. The acquisition unit 11 may acquire information indicating an updated firmware version or the like when restarting the optical relay device 20. Then, the control unit 13 may determine whether to maintain the setting of the gain of the detachable optical amplifier based on the updated firmware version or the like. As a result, for example, in a case where the update content of the firmware or the like of the optical relay device 20 is irrelevant to the processing of the optical signal and thus does not affect the threshold value of the signal quality or the like, the re-measurement of the signal quality for the gain setting can be omitted.

### Others

In an optical multiplex transmission system, a transponder that is an optical transmission/reception unit and a Reconfigurable optical add-drop multiplexer (ROADM) that performs multiplexing (multiplexing) and amplification are generally installed in the same device or the same station. In recent years, there has been a demand for dispersion of transponders along with an increase in demand for large-capacity communication. In this case, for example, the transponder is considered to be arranged not only in the station but also in a user facility (e.g., building) managed by the user. In this case, it is considered that compensation or the like of an optical signal in a section between the transponder and the ROADM may be required.

In a case where a transmission loss cannot be tolerated in the optical communication, an optical signal can be compensated by arranging an optical amplifier. However, in a case where the transmission loss can be tolerated, arranging the optical amplifier is an extra cost. On the other hand, according to the present disclosure, amplifiers can be appropriately arranged in the optical communication system.

### Modified Example

The information processing device 10 may be a device included in one housing, but the information processing device 10 of the present disclosure is not limited thereto. Each unit of the information processing device 10 may be implemented by, for example, cloud computing including one or more computers. Furthermore, the information processing device 10 may be incorporated in the optical relay device 20, the transmitting-side detachable optical amplifier 22, the receiving-side detachable optical amplifier 24, or the station optical relay device 30. Furthermore, the processing of at least some of the functional units of the information processing device 10 may be executed by at least one of the optical relay device 20, the transmitting-side detachable optical amplifier 22, the receiving-side detachable optical amplifier 24, and the station optical relay device 30. Such an information processing device 10 is also included in an example of the “information processing device” according to the present disclosure.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Some or all of the above example embodiments may also be described as the following supplementary notes, but are not limited to the following. Some or all of the elements (e.g., configuration and function) described in each supplementary note dependent on supplementary note 1 can also be dependent on an independent supplementary note of another category in a similar dependency relationship. Some or all of the elements described in any supplementary notes may be applied to various types of hardware, software, recording means for recording software, systems, and methods.

### Supplementary Note 1

An information processing device including,

an acquisition unit that acquires information indicating whether a detachable optical amplifier that amplifies at least one of a transmission optical signal and a reception optical signal is connected to a first optical relay device,

a determination unit that determines, in a case where the detachable optical amplifier is connected to the first optical relay device, a gain of the detachable optical amplifier based on a signal quality between the first optical relay device and a second optical relay device that communicates with the first optical relay device by an optical signal, and

a control unit that causes the gain determined by the determination unit to be set in the detachable optical amplifier.

### Supplementary Note 2

The information processing device according to supplementary note 1, in which

the acquisition unit acquires information indicating the gain set in the detachable optical amplifier, and

the control unit causes, in a case where the gain set in the detachable optical amplifier is different from the gain determined by the determination unit, a warning to be notified.

### Supplementary Note 3

The information processing device according to supplementary note 2, in which the control unit causes information indicating the gain determined by the determination unit to be notified.

### Supplementary Note 4

The information processing device according to supplementary note 1 or 2, in which

the acquisition unit acquires information indicating a type of the detachable optical amplifier, and

the determination unit determines the gain of the detachable optical amplifier based on the type of the detachable optical amplifier and the signal quality.

### Supplementary Note 5

The information processing device according to supplementary note 1 or 2, in which in a case where the first optical relay device is restarted, the control unit determines whether to update the gain set in the detachable optical amplifier.

### Supplementary Note 6

The information processing device according to supplementary note 1 or 2, in which in a case where the detachable optical amplifier is not connected to the first optical relay device and the signal quality is equal to or less than a threshold value, the control unit causes information indicating that connection of the detachable optical amplifier is necessary to be notified.

### Supplementary Note 7

The information processing device according to supplementary note 1 or 2, in which in a case where the detachable optical amplifier is not connected to the first optical relay device and the signal quality is not equal to or less than a threshold value, the control unit causes information indicating that connection of the detachable optical amplifier is unnecessary to be notified.

### Supplementary Note 8

The information processing device according to supplementary note 1 or 2, in which in a case where the detachable optical amplifier is connected to the first optical relay device and the signal quality is not equal to or less than a threshold value without increasing the gain by the detachable optical amplifier, the control unit causes information indicating that connection of the detachable optical amplifier is unnecessary to be notified.

### Supplementary Note 9

An optical communication system including

an information processing device,

a detachable optical amplifier that amplifies at least one of a transmission optical signal and a reception optical signal, and

a first optical relay device,

in which the information processing device includes,

an acquisition unit that acquires information indicating whether the detachable optical amplifier is connected to the first optical relay device,

a determination unit that determines, in a case where the detachable optical amplifier is connected to the first optical relay device, a gain of the detachable optical amplifier based on a signal quality between the first optical relay device and a second optical relay device that communicates with the first optical relay device by an optical signal, and

a control unit that causes the gain determined by the determination unit to be set in the detachable optical amplifier.

### Supplementary Note 10

An optical relay device including,

a detachable portion to which a detachable optical amplifier that amplifies at least one of a transmission optical signal and a reception optical signal is detachable, and

a control unit that sets, in the detachable optical amplifier, a gain setting according to a signal quality between the optical relay device and another optical relay device that communicates with the optical relay device by an optical signal.

What is claimed is:

1. An information processing device comprising:
at least one memory storing instructions, and
at least one processor configured to execute the instructions to:
acquire information indicating whether a detachable optical amplifier that amplifies at least one of a transmission optical signal and a reception optical signal is connected to a first optical relay device, and
determine, in a case where the detachable optical amplifier is connected to the first optical relay device, a gain of the detachable optical amplifier based on a signal quality between the first optical relay device and a second optical relay device that communicates with the first optical relay device by an optical signal,
wherein the gain determined by the determination is caused to be set in the detachable optical amplifier.

2. The information processing device according to claim 1, wherein
the acquiring includes acquiring information indicating the gain set in the detachable optical amplifier; and
in a case where the gain set in the detachable optical amplifier is different from the gain determined by the determination, a warning is caused to be notified.

3. The information processing device according to claim 2, wherein information indicating the gain determined by the determination is caused to be notified.

4. The information processing device according to claim 1, wherein
the acquiring includes acquiring information indicating a type of the detachable optical amplifier; and
the determining includes determining the gain of the detachable optical amplifier based on the type of the detachable optical amplifier and the signal quality.

5. The information processing device according to claim 1, wherein in a case where the first optical relay device is restarted, whether to update the gain set in the detachable optical amplifier is determined.

6. The information processing device according to claim 1, wherein in a case where the detachable optical amplifier is not connected to the first optical relay device and the signal quality is equal to or less than a threshold value, information indicating that connection of the detachable optical amplifier is necessary is caused to be notified.

7. The information processing device according to claim 1, wherein in a case where the detachable optical amplifier is not connected to the first optical relay device and the signal quality is not equal to or less than a threshold value, information indicating that connection of the detachable optical amplifier is unnecessary is caused to be notified.

8. The information processing device according to claim 1, wherein in a case where the detachable optical amplifier is connected to the first optical relay device and the signal quality is not equal to or less than a threshold value without increasing the gain by the detachable optical amplifier, information indicating that connection of the detachable optical amplifier is unnecessary is caused to be notified.

9. An optical communication system including
an information processing device,
a detachable optical amplifier that amplifies at least one of a transmission optical signal and a reception optical signal, and
a first optical relay device, wherein
the information processing device includes,
at least one memory storing instructions, and
at least one processor configured to execute the instructions to:
acquire information indicating whether the detachable optical amplifier is connected to the first optical relay device, and
determine, in a case where the detachable optical amplifier is connected to the first optical relay device, a gain of the detachable optical amplifier based on a signal quality between the first optical relay device and a second optical relay device that communicates with the first optical relay device by an optical signal; and
the gain determined by the determination is caused to be set in the detachable optical amplifier.

10. The optical communication system according to claim 9, wherein
the acquiring includes acquiring information indicating the gain set in the detachable optical amplifier; and
in a case where the gain set in the detachable optical amplifier is different from the gain determined by the determination, a warning is caused to be notified.

11. The optical communication system according to claim 10, wherein information indicating the gain determined by the determination is caused to be notified.

12. The optical communication system according to claim 9, wherein
the acquiring includes acquiring information indicating a type of the detachable optical amplifier; and
the determining includes determining the gain of the detachable optical amplifier based on the type of the detachable optical amplifier and the signal quality.

13. The optical communication system according to claim 9, wherein in a case where the first optical relay device is restarted, whether to update the gain set in the detachable optical amplifier is determined.

14. The optical communication system according to claim 9, wherein in a case where the detachable optical amplifier is not connected to the first optical relay device and the signal quality is equal to or less than a threshold value, information indicating that connection of the detachable optical amplifier is necessary is caused to be notified.

15. The optical communication system according to claim 9, wherein in a case where the detachable optical amplifier is not connected to the first optical relay device and the signal quality is not equal to or less than a threshold value, information indicating that connection of the detachable optical amplifier is unnecessary is caused to be notified.

16. The optical communication system according to claim 9, wherein in a case where the detachable optical amplifier is connected to the first optical relay device and the signal quality is not equal to or less than a threshold value without increasing the gain by the detachable optical amplifier, information indicating that connection of the detachable optical amplifier is unnecessary is caused to be notified.

17. An optical relay device comprising:
a detachable portion to which a detachable optical amplifier that amplifies at least one of a transmission optical signal and a reception optical signal is detachable; and
a control unit that sets, in the detachable optical amplifier, a gain setting according to a signal quality between the optical relay device and another optical relay device that communicates with the optical relay device by an optical signal.

18. The optical relay device according to claim 17, wherein in a case where the optical relay device is restarted, the control unit determines whether to update the gain set in the detachable optical amplifier.

19. The optical relay device according to claim 17, wherein in a case where the detachable optical amplifier is not connected to the optical relay device and the signal quality is equal to or less than a threshold value, the control unit causes information indicating that connection of the detachable optical amplifier is necessary to be notified.

20. The optical relay device according to claim 17, wherein in a case where the detachable optical amplifier is not connected to the optical relay device and the signal quality is not equal to or less than a threshold value, the control unit causes information indicating that connection of the detachable optical amplifier is unnecessary to be notified.
